(19) United States
(12) Patent Application Publication
(10) Pub. No.: US 2023/0395873 A1
(43) Pub. Date: Dec. 7, 2023

(54) Iron Zinc Battery

(71) Applicant: Nippon Telegraph and Telephone Corporation, Tokyo (JP)

(72) Inventors: Masaya Nohara, Musashino-shi, Tokyo (JP); Mikayo Iwata, Musashino-shi, Tokyo (JP); Hiroaki Taguchi, Musashino-shi, Tokyo (JP); Takeshi Komatsu, Musashino-shi, Tokyo (JP)

(21) Appl. No.: 18/249,409

(22) PCT Filed: Nov. 11, 2020
(86) PCT No.: PCT/JP2020/042120

§ 371 Date: Apr. 18, 2023

(51) Int. Cl. H01M 10/38; H01M 4/52; H01M 4/42

(52) U.S. Cl. CPC H01M 10/38; H01M 4/521; H01M 4/42; H01M 2004/029

(57) ABSTRACT

An iron-zinc battery includes a positive electrode containing iron oxyhydroxide, a negative electrode containing zinc, and an aqueous electrolytic solution disposed between the positive electrode and the negative electrode. The aqueous electrolytic solution contains zinc chloride (ZnCl2), and the weight of the zinc chloride (ZnCl2) is equal to or more than the weight of water (H2O) contained in the aqueous electrolytic solution.

### TECHNICAL FIELD

The present invention relates to an iron-zinc battery.

### BACKGROUND ART

Conventionally, a disposable primary battery and a rechargeable secondary battery such as an alkaline battery, a manganese battery, a high-performance coin type lithium primary battery, a nickel-cadmium battery, a nickel-metal hydride battery, or a lithium ion battery have been widely used for a small device, a sensor, a mobile device, and the like. In addition, in recent development of Internet of Things (IoT), development of a scattered type sensor installed and used throughout nature such as in the soil and the forest is also in progress.

Currently, a battery generally used is often made of a rare metal such as lithium, nickel, manganese, or cobalt, and there is a problem of resource depletion.

In addition, an air battery having a low environmental load has been studied (Patent Literature 1).

### CITATION LIST

### Patent Literature

Patent Literature 1: WO2018/003724

### SUMMARY OF INVENTION

### Technical Problem

The battery principle of Patent Literature 1 is an air battery, and since oxygen in air is used as a positive electrode active material, an air intake port is essential for the battery. Therefore, the air battery has a disadvantage that an electrolytic solution volatilizes from the air intake port and is not suitable for long-term storage. Therefore, a new battery having a low environmental load capable of battery reaction in a sealed system is required.

The present invention has been made in view of the above circumstances, and an object of the present invention is to provide an iron-zinc battery that can be stored for a long period of time with a low environmental load.

### Solution to Problem

An iron-zinc battery according to an aspect of the present invention includes a positive electrode containing iron oxyhydroxide, a negative electrode containing zinc, and an aqueous electrolytic solution disposed between the positive electrode and the negative electrode. The aqueous electrolytic solution contains zinc chloride (ZnCl₂), and the weight of the zinc chloride (ZnCl₂) is equal to or more than the weight of water (H₂O) contained in the aqueous electrolytic solution.

### Advantageous Effects of Invention

The present invention can provide an iron-zinc battery that can be stored for a long period of time with a low environmental load.

### BRIEF DESCRIPTION OF DRAWINGS

FIG. 1 is a basic schematic diagram of an iron-zinc battery of the present embodiment.

FIG. 2 is a schematic cross-sectional view illustrating a structure of a coin type iron-zinc battery.

FIG. 3A is a configuration diagram illustrating a configuration example of a bipolar type stack iron-zinc battery.

FIG. 3B is a plan view illustrating a configuration example of the bipolar type stack iron-zinc battery.

FIG. 4 is a graph illustrating an initial charge/discharge curve of an iron-zinc battery of Example 1.

FIG. 5 is a diagram illustrating cycle dependency of a discharge capacity of each of iron-zinc batteries of Examples 1 to 4.

### DESCRIPTION OF EMBODIMENTS

Hereinafter, an embodiment of the present invention will be described with reference to the drawings.

### Configuration of Iron-Zinc Battery

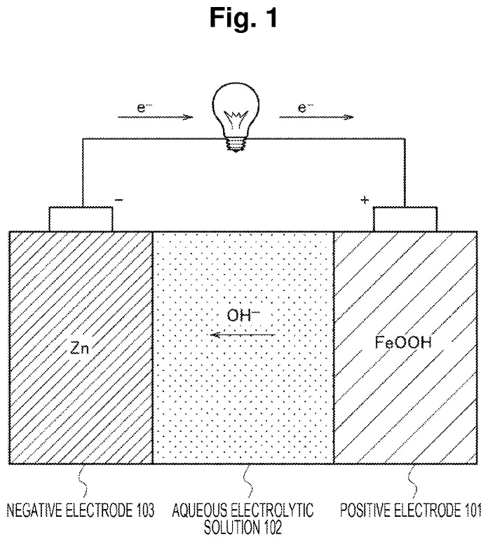

FIG. 1 is a configuration diagram illustrating a configuration of an iron-zinc battery according to the embodiment of the present invention. This iron-zinc battery includes a positive electrode 101 containing iron oxyhydroxide, a negative electrode 103 containing zinc, and an aqueous electrolytic solution 102 disposed between the positive electrode 101 and the negative electrode 103.

Specifically, the positive electrode 101 is formed using iron oxyhydroxide as an active material. The negative electrode 103 is formed using zinc as an active material. The aqueous electrolytic solution 102 is disposed so as to be in contact with the positive electrode 101 and the negative electrode 103. As described above, the iron-zinc battery of the present embodiment is characterized in that the positive electrode 101 contains an active material of iron oxyhydroxide and the negative electrode 103 contains an active material of zinc.

A discharge reaction in the positive electrode 101 can be expressed as follows.

2FeOOH+2H₂O+2e⁻→2Fe(OH)₂+2OH⁻ (1)

The hydroxide ions (OH⁻) in the above formula are dissolved in the aqueous electrolytic solution 102 by electrochemical reduction from the positive electrode 101, and move to a surface of the negative electrode 103 in the aqueous electrolytic solution 102. A charge reaction is a reverse reaction of the above formula.

A discharge reaction in the negative electrode 103 can be expressed as follows.

Zn+4OH⁻→Zn(OH)₄²⁻+2e⁻ (2)

By a reaction between the hydroxide ions (OH⁻) in the above formula and the negative electrode 103, the zinc tetrahydroxide ions (Zn(OH)₄²⁻) are dissolved in the electrolytic solution 102. A charge reaction is a reverse reaction of the above formula, and the zinc tetrahydroxide ions (Zn(OH)₄²⁻) dissolved in the aqueous electrolytic solution 102 are precipitated on the negative electrode 103.

By these reactions of formulas (1) and (2), discharge is possible, and a total reaction can be expressed as follows.

2FeOOH+Zn+2H₂O+2OH⁻→2Fe(OH)₂+Zn(OH)₄²⁻ (3)

A theoretical electromotive force is about 0.55 V (when α-FeOOH is used for a positive electrode active material), which is smaller than those of other battery systems. However, by using iron oxyhydroxide as a positive electrode active material, zinc as a negative electrode active material, and an aqueous electrolytic solution as an electrolytic solution, the iron-zinc battery of the present embodiment can be expected as a battery made of an inexpensive material and having a low environmental load.

The positive electrode 101 can contain a positive electrode active material and a conductive auxiliary agent as constituent elements. In addition, the positive electrode 101 preferably contains a binder for integrating the materials.

The negative electrode 103 can contain a negative electrode active material and a conductive auxiliary agent as constituent elements. In addition, the negative electrode 103 preferably contains a binder for integrating the materials.

Each of the above constituent elements will be described below.

### (1) Positive Electrode

The positive electrode contains at least a positive electrode active material, and can contain an additive such as a conductive auxiliary agent or a binder as necessary. The positive electrode may be applied to a sheet-like current collector containing at least one selected from the group consisting of copper, iron, and carbon.

### (1-1) Positive Electrode Active Material

The positive electrode active material of the present embodiment contains at least iron oxyhydroxide (FeOOH). Iron oxyhydroxide has four phases of an α phase, a β phase, a γ phase, and a δ phase having different crystal forms, but the α phase is preferable from a viewpoint of cost and productivity.

The positive electrode active material has a particle size of preferably 0.3 μm to 10 μm, more preferably 0.5 μm to 5 μm.

This is because, as the particle size is smaller, the number of sites to be reacted increases and output performance is improved, and on the other hand, by repeating a charge/discharge cycle, electrical contact with the positive electrode active material, the conductive auxiliary agent, and the current collector is impaired, and cycle performance is deteriorated.

Iron oxyhydroxide can be produced by an existing method such as a method for oxidizing iron hydroxide (Fe(OH)₂) in a pH-controlled aqueous solution, a method for heating an iron chloride (FeCl₃) aqueous solution, or a method for adding hydrogen peroxide (H₂O₂) to an iron hydroxide (Fe(OH)₂) dispersion. Commercially available iron oxyhydroxide can also be used.

### (1-2) Conductive Auxiliary Agent

In the present embodiment, the positive electrode may contain a conductive auxiliary agent. As the conductive auxiliary agent, for example, carbon can be used. Specific examples thereof include carbon blacks such as Ketjen black and acetylene black, activated carbons, graphites, and carbon fibers. In order to sufficiently ensure a reaction site in the positive electrode, carbon having a small particle size is suitable. Specifically, carbon having a particle size of 1 μm or less is desirable. The carbon can be obtained, for example, as a commercially available product or by a known synthesis.

The positive electrode active material may be directly coated with carbon. Examples of a coating method include a physical method such as vapor deposition, sputtering, or a planetary ball mill, a chemical method such as coating the positive electrode active material with an organic substance and then performing a heat treatment, and a known method.

### (1-3) Binder

The positive electrode may contain a binder. The binder is not particularly limited, and examples thereof include polytetrafluoroethylene (PTFE), polyvinylidene fluoride (PVDF), a styrene butadiene rubber, an ethylene propylene diene rubber, and a natural rubber. A styrene butadiene rubber, an ethylene propylene diene rubber, and a natural rubber in which fluorine is not used are more preferable from a viewpoint of environmental load and disposal treatment.

These binders can be used as a powder or as a dispersion.

Regarding the contents of the positive electrode active material, the conductive auxiliary agent, and the binder in the positive electrode of the present embodiment, the content of the positive electrode active material is more than 0% by weight and 99% or less and preferably 70 to 95% by weight, the content of the conductive auxiliary agent is 0 to 90% by weight and preferably 1 to 30% by weight, and the content of the binder is 0 to 50% by weight and preferably 1 to 30% by weight based on the weight of the entire positive electrode.

### (1-4) Preparation of Positive Electrode

The positive electrode can be prepared as follows. The positive electrode can be formed by mixing iron oxyhydroxide powder as a positive electrode active material, carbon powder, and as necessary, a dispersion such as a styrene-butadiene rubber, applying the mixture to a current collector, and drying the mixture.

The current collector is not particularly limited, and for example, a sheet-like or mesh-like current collector using at least one (one element) selected from the group consisting of copper, iron, titanium, nickel, and carbon can be used.

In order to assemble a battery into a bipolar type stack structure described later, the current collector is preferably a sheet-like current collector. In addition, the current collector is more preferably a sheet-like current collector containing at least one selected from the group consisting of copper, iron, and carbon from a viewpoint of environmental load and disposal. As described above, the positive electrode is preferably applied to a sheet-like current collector containing at least one selected from the group consisting of copper, iron, and carbon.

In order to increase the strength of the electrode, cold pressing or hot pressing is applied to the dried electrode, whereby a more stable positive electrode can be produced.

As described above, by producing the positive electrode containing iron oxyhydroxide as a positive electrode active material, a positive electrode highly active to a charge reaction and a discharge reaction can be obtained. Furthermore, by producing the positive electrode of the iron-zinc battery having the above-described configuration, it is possible to sufficiently draw a potential of iron oxyhydroxide as a positive electrode active material.

### (2) Negative Electrode

The negative electrode contains at least a negative electrode active material, and can contain an additive such as a conductive auxiliary agent or a binder as necessary. The negative electrode may be applied to a sheet-like current collector containing at least one selected from the group consisting of copper, iron, and carbon.

### (2-1) Negative Electrode Active Material

The negative electrode active material of the present embodiment contains at least zinc (Zn). The negative electrode active material can be produced by molding a zinc foil into a predetermined shape, but is preferably used in a form of powder.

The negative electrode active material has a particle size of preferably 0.3 μm to 10 μm, more preferably 0.5 μm to 5 μm. This is because, as the particle size is smaller, the number of sites to be reacted increases and output performance is improved, and on the other hand, when the particle size is too small, progress of oxidation of zinc and corrosion by the electrolytic solution is accelerated.

### (2-2) Conductive Auxiliary Agent

In the present embodiment, the negative electrode may contain a conductive auxiliary agent. As the conductive auxiliary agent, for example, carbon can be used. Specific examples thereof include carbon blacks such as Ketjen black and acetylene black, activated carbons, graphites, and carbon fibers. In order to sufficiently ensure a reaction site in the negative electrode, carbon having a small particle size is suitable. Specifically, carbon having a particle size of 1 μm or less is desirable. The carbon can be obtained, for example, as a commercially available product or by a known synthesis.

The negative electrode active material may be directly coated with carbon. Examples of a coating method include a physical method such as vapor deposition, sputtering, or a planetary ball mill, a chemical method such as coating the negative electrode active material with an organic substance and then performing a heat treatment, and a known method.

### (2-3) Binder

The negative electrode may contain a binder. The binder is not particularly limited, and examples thereof include polytetrafluoroethylene (PTFE), polyvinylidene fluoride (PVDF), a styrene butadiene rubber, an ethylene propylene diene rubber, and a natural rubber. A styrene butadiene rubber, an ethylene propylene diene rubber, and a natural rubber in which fluorine is not used are more preferable from a viewpoint of environmental load and disposal treatment. These binders can be used as a powder or as a dispersion.

Regarding the contents of the negative electrode active material, the conductive auxiliary agent, and the binder of the present embodiment, the content of the negative electrode active material is more than 0% by weight and 99% or less and preferably 70 to 95% by weight, the content of the conductive auxiliary agent is 0 to 90% by weight and preferably 1 to 30% by weight, and the content of the binder is 0 to 50% by weight and preferably 1 to 30% by weight based on the weight of the entire negative electrode.

### (2-4) Preparation of Negative Electrode

The negative electrode can be prepared as follows. The negative electrode can be formed by mixing zinc powder as a negative electrode active material, carbon powder, and as necessary, a dispersion such as a styrene-butadiene rubber, applying the mixture to a current collector, and drying the mixture.

The current collector is not particularly limited, and for example, a sheet-like or mesh-like current collector using at least one (one element) selected from the group consisting of copper, iron, titanium, nickel, and carbon can be used.

In order to assemble a battery into a bipolar type stack structure described later, the current collector is preferably a sheet-like current collector. In addition, the current collector is more preferably a sheet-like current collector containing at least one selected from the group consisting of copper, iron, and carbon from a viewpoint of environmental load and disposal. As described above, the negative electrode is preferably applied to a sheet-like current collector containing at least one selected from the group consisting of copper, iron, and carbon.

In order to increase the strength of the electrode, cold pressing or hot pressing is applied to the dried electrode, whereby a more stable negative electrode can be produced.

As described above, by producing the negative electrode containing zinc as a negative electrode active material, a negative electrode highly active to a charge reaction and a discharge reaction can be obtained. Furthermore, by producing the negative electrode of the iron-zinc battery having the above-described configuration, it is possible to sufficiently draw a potential of zinc as a negative electrode active material.

### (3) Aqueous Electrolytic Solution

The iron-zinc battery of the present embodiment includes an aqueous electrolytic solution in which hydroxide ions (OH⁻) can move between the positive electrode and the negative electrode. The aqueous electrolytic solution of the present embodiment is an aqueous solution containing zinc chloride (ZnCl₂) as an electrolyte. The aqueous electrolytic solution may contain another electrolyte in addition to zinc chloride (ZnCl₂). As the other electrolyte, for example, at least one selected from the group consisting of an acetate, a carbonate, a phosphate, a pyrophosphate, a metaphosphate, a citrate, a borate, an ammonium salt, a formate, a hydrogen carbonate, a hydroxide, and a chloride may be used. Therefore, the aqueous electrolytic solution may contain zinc chloride (ZnCl₂) and at least one selected from the above group.

The aqueous electrolytic solution may be in any form such as a liquid form, a cream form, a gel form, or a solid form. However, when the electrolytic solution is in a gel form or a solid form, it is referred to as a solid electrolyte.

Usually, a strong alkaline aqueous solution such as potassium hydroxide (KOH) is used as the electrolytic solution, but in the present embodiment, an aqueous electrolytic solution containing zinc chloride (ZnCl₂) is used. In order to improve performance, it is preferable to increase the specific gravity of zinc chloride (ZnCl₂) in the aqueous electrolytic solution.

Specifically, the aqueous electrolytic solution is preferably a zinc chloride (ZnCl₂) aqueous solution which contains zinc chloride (ZnCl₂) and in which the weight of zinc chloride (ZnCl₂) is equal to or more than the weight of water (H₂O) contained in the aqueous electrolytic solution. The aqueous electrolytic solution is more preferably a zinc chloride (ZnCl₂) concentrated electrolytic solution containing 3 mol or less of water (H₂O) with respect to 1 mol of zinc chloride (ZnCl₂).

Note that when the content of water (H₂O) is about 7.6 mol with respect to 1 mol of zinc chloride (ZnCl₂), the weight of zinc chloride (ZnCl₂) is equal to the weight of water (H₂O). A saturated aqueous solution of zinc chloride (ZnCl₂) contains about 2.1 mol of water (H₂O) with respect to 1 mol of zinc chloride (ZnCl₂).

Normally, zinc in contact with water reacts with water to form a coating film of zinc oxide (ZnO) or zinc hydroxide (Zn(OH)₂), which increases battery overvoltage. However, by using a zinc chloride (ZnCl₂) concentrated electrolytic solution containing 3 mol or less of water (H₂O) with respect to 1 mol of zinc chloride (ZnCl₂), all water molecules in the electrolytic solution are coordinated to zinc ions (Zn²⁺). Therefore, a reaction between water molecules and zinc is suppressed, a coating film is hardly formed, and an operating voltage can be improved.

Even in a case of a zinc chloride (ZnCl₂) aqueous solution containing more than 3 mol of water (H₂O) with respect to 1 mol of zinc chloride (ZnCl₂), a reaction between water molecules and zinc is suppressed to some extent according to a ratio between zinc chloride (ZnCl₂) and water, and an operating voltage can be improved.

In addition, as described above, during charging in the negative electrode of the iron-zinc battery, zinc tetrahydroxide ions (Zn(OH)₄²⁻) dissolved during discharging are precipitated as zinc (Zn) on the negative electrode. At this time, dendritic zinc (dendrite) grows, and the negative electrode is rapidly deteriorated. Further continuous growth causes a problem of damaging the separator and short-circuiting the battery. It is considered that this problem due to the dendrite is caused by a coating film of zinc oxide (ZnO) or zinc hydroxide (Zn(OH)₂) generated by reaction with water and a concentration gradient of zinc ions in the electrolytic solution. Therefore, by using the zinc chloride (ZnCl₂) concentrated electrolytic solution, it is possible to suppress the coating film and the concentration gradient of zinc ions, and to suppress formation of the dendrite.

Even in a case of a zinc chloride (ZnCl₂) aqueous solution containing more than 3 mol of water (H₂O) with respect to 1 mol of zinc chloride (ZnCl₂), formation of the dendrite can be suppressed to some extent according to a ratio between zinc chloride (ZnCl₂) and water.

### (4) Other Elements

In addition to the above constituent elements, the iron-zinc battery of the present embodiment can include a structural member such as a separator or a battery case, and other elements required for the iron-zinc battery. As these elements, conventionally known ones can be used, but it is preferable not to contain a harmful substance, a rare metal, a rare earth, or the like from a viewpoint of environmental load and disposal treatment. Furthermore, these other elements are more preferably bio-derived or biodegradable materials.

### (5) Method for Manufacturing Iron-Zinc Battery

As described above, the iron-zinc battery of the present embodiment includes at least a positive electrode, a negative electrode, and an aqueous electrolytic solution, and as illustrated in FIG. 1, the aqueous electrolytic solution is disposed between the positive electrode and the negative electrode so as to be in contact with the positive electrode and the negative electrode. The iron-zinc battery having such a configuration can be prepared in a similar manner to a conventional secondary battery.

For example, for the iron-zinc battery, it is only required to assemble a positive electrode including a positive electrode active material containing iron oxyhydroxide, a conductive auxiliary agent, and a binder, a negative electrode including a negative electrode active material containing zinc, a conductive auxiliary agent, and a binder, and an aqueous electrolytic solution disposed so as to be in contact with the positive electrode and the negative electrode, as described above, in accordance with a conventional technique.

### (5-1) Method for Manufacturing Coin Type Iron-Zinc Battery

As an embodiment of the method for manufacturing an iron-zinc battery, for example, a coin type iron-zinc battery can be manufactured.

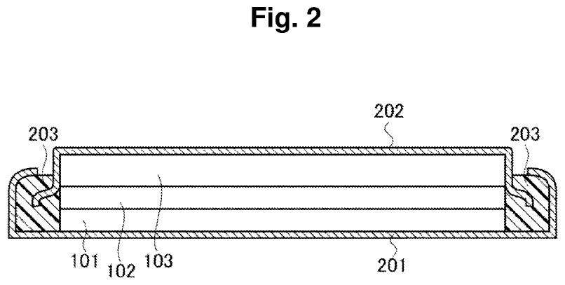

FIG. 2 is a schematic cross-sectional view illustrating a structure of a coin type iron-zinc battery. Specifically, first, a separator (not illustrated) is placed on a positive electrode case 201 in which the positive electrode 101 is disposed, and the electrolytic solution 102 is injected into the placed separator. Next, the negative electrode 103 is disposed on the electrolytic solution 102, and the positive electrode case 201 is covered with a negative electrode case 202. Next, a peripheral portion of the positive electrode case 201 and the negative electrode case 202 is crimped with a coin cell crimping machine, whereby a coin type iron-zinc battery including a propylene gasket 203 can be produced.

The illustrated coin type iron-zinc battery uses iron oxyhydroxide powder as a positive electrode active material. Therefore, unlike an air battery using oxygen in air as a positive active material, it is not necessary to form an air intake port in the positive electrode case 201 of the present embodiment. That is, in the present embodiment, a sealed battery can be produced. Therefore, the iron-zinc battery of the present embodiment can be stored for a long period of time without volatilizing an electrolytic solution from the air intake port.

### (5-2) Method for Manufacturing Bipolar Type Stack Structure Iron-Zinc Battery

As an embodiment of the method for manufacturing an iron-zinc battery, for example, an iron-zinc battery having a bipolar type stack structure can be manufactured.

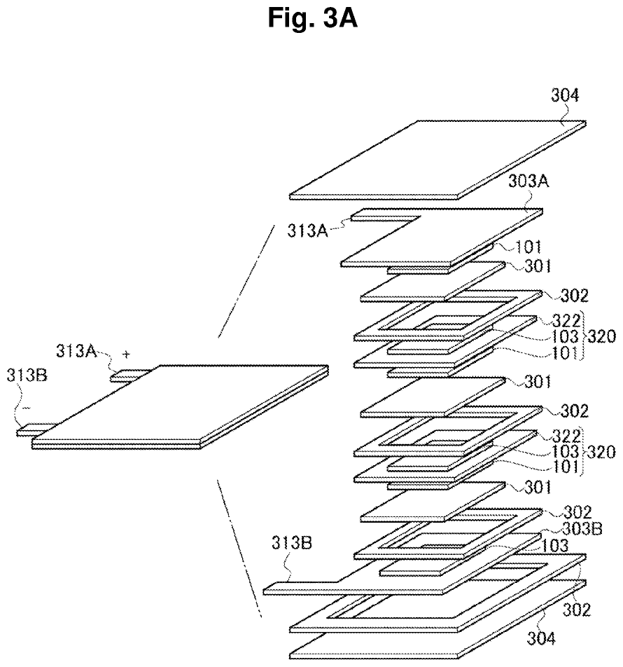

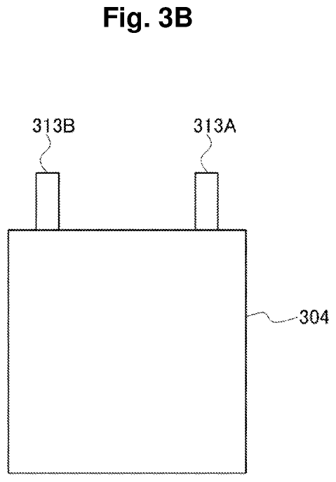

FIG. 3A is a configuration diagram illustrating a configuration example of a bipolar type stack iron-zinc battery. FIG. 3B is a plan view illustrating a configuration example of the bipolar type stack iron-zinc battery.

The iron-zinc battery of the present embodiment has a low theoretical battery voltage in a single cell, and therefore output performance cannot be expected. Therefore, it is preferable to increase output by forming an iron-zinc battery having a stack structure.

Specifically, first, the positive electrode 101 and the negative electrode 103 are applied onto both surfaces of a current collector 322 such as a copper foil, respectively, and dried and pressed to form the positive electrode 101 and the negative electrode 103 on the one current collector 322. As a result, a bipolar electrode 320 in which the positive electrode 101 and the negative electrode 103 are applied to surface of the current collector 322, respectively is produced.

It is only required to form an electrode on only one surface of each of outermost layer current collectors 303A and 303B, and the current collectors 303A and 303B preferably have tabs 313A and 313B for extracting electricity, respectively. The positive electrode 101 is formed on only one surface of the illustrated outermost layer current collector 303A, and the current collector 303A has the tab 313A. The negative electrode 103 is formed on only one surface of the outermost layer current collector 303B, and the current collector 303B has the tab 313B.

The tabs 313A and 313B may be processed so as to protrude from the current collectors 303A and 303B, respectively, or another metal tab may be joined to each of the current collectors 303A and 303B by ultrasonic welding, spot welding, or the like.

The current collectors 322 on each of which the positive electrode 101 and the negative electrode 103 are formed are stacked such that the positive electrode 101 and the negative electrode 103 face each other, and a separator 301 is inserted between the current collectors 322 so as to be in contact with the positive electrode 101 and the negative electrode 103. Similarly, each of the outermost layer current collectors 303A and 303B on which the positive electrode 101 or the negative electrode 103 is formed is stacked such that the positive electrode 101 and the negative electrode 103 face each other, and the separator 301 is inserted so as to be in contact with the positive electrode 101 and the negative electrode 103.

After the current collectors 303A, 303B, and 322 and the separator 301 are stacked, a peripheral portion of copper foils of the current collectors is thermally pressed using a thermally fusible sheet 302 to be sealed. However, it is necessary to open one side (part) of the peripheral portion without thermally pressing the one side (part) in order to inject an aqueous electrolytic solution described later.

The produced stack is held with an aluminum laminate film 304 and the like, and an aqueous electrolytic solution is injected into each cell (each room), and then the unsealed side of the stack and a peripheral portion of the aluminum laminate films are vacuum-sealed, whereby a bipolar type stack structure iron-zinc battery can be produced.

Such an iron-zinc battery is a sealed battery that does not require an air intake port, unlike an air battery using oxygen in air as a positive electrode active material. Therefore, the iron-zinc battery of the present embodiment can be stored for a long period of time without volatilizing an electrolytic solution from the air intake port.

### EXAMPLES

Hereinafter, Examples of the iron-zinc battery according to the present embodiment will be described in detail. Note that the present invention is not limited to those described in the following Examples, and can be appropriately modified and implemented without changing the gist thereof.

### Example 1

In Example 1, the above-described coin type iron-zinc battery (FIG. 2) was produced by the following procedure. In addition, a zinc plate was used as a negative electrode active material, and a zinc chloride (ZnCl₂) aqueous solution in which a weight ratio between zinc chloride (ZnCl₂) and water (H₂O) was (ZnCl₂):water (H₂O)=1:1 was used as an aqueous electrolytic solution.

### Preparation of Positive Electrode

Iron oxyhydroxide powder (particle size: 1 μm, Kojundo Chemical Laboratory Co., Ltd.), Ketjen black powder (EC600JD, Lion Specialty Chemicals), and polytetrafluoroethylene (PTFE) powder were sufficiently pulverized and mixed at a weight ratio of 80:10:10 using a roughing machine, and roll-formed to produce a sheet-like electrode (thickness: 0.5 mm). This sheet-like electrode was cut into a circle having a diameter of 16 mm and pressed on a copper mesh to obtain a positive electrode.

### Preparation of Negative Electrode

A zinc plate (thickness: 150 μm, The Nilaco Corporation) was cut into a circle having a diameter of 16 mm to obtain a negative electrode.

### Preparation of Iron-Zinc Battery

A coin type iron-zinc battery illustrated in FIG. 2 was produced using a coin battery case (Hohsen Corp.). A cellulose-based separator (NIPPON KODOSHI CORPORATION) cut out into a circle having a diameter of 18 mm was placed on the positive electrode case 201 in which the positive electrode 101 prepared by the above method was disposed, and a 7.6 mol/L zinc chloride (ZnCl₂) aqueous solution was injected as the aqueous electrolytic solution 102 into the placed separator. The negative electrode 103 was disposed on the aqueous electrolytic solution 102, and the positive electrode case 201 was covered with the negative electrode case 202, and a peripheral portion of the positive electrode case 201 and the negative electrode case 202 was crimped with a coin cell crimping machine, whereby a coin type iron-zinc battery including the propylene gasket 203 was obtained.

### Battery Performance

Battery performance of the iron-zinc battery prepared by the above procedure was measured. In a cycle test of the battery, a current was caused to flow at a current density per effective area of the positive electrode of 1 mA/cm 2 using a charge/discharge measurement system (manufactured by Bio Logic), and a discharge voltage was measured until a battery voltage decreased from an open circuit voltage to 0.20 V. In addition, a charge test of the battery was performed at the same current density as that during discharging until the battery voltage increased to 1.0 V. The discharge test of the battery was performed under a normal living environment. A charge/discharge capacity is represented by a value (mAh/g) per unit weight of the positive electrode active material (iron oxyhydroxide).

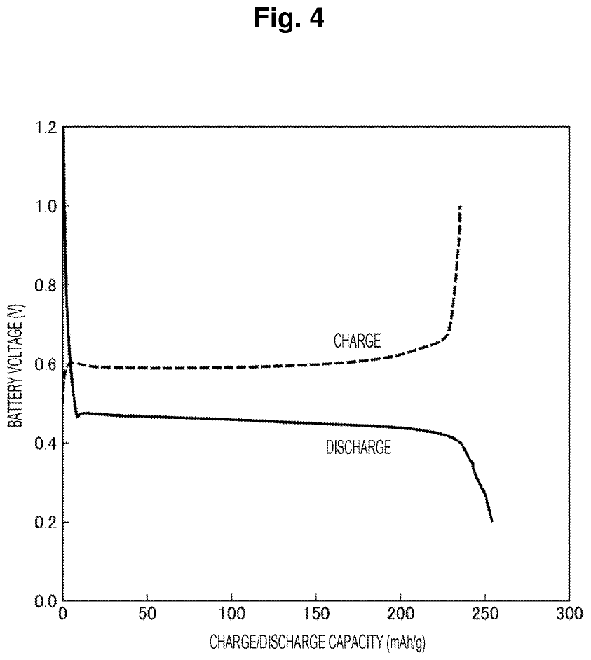

FIG. 4 illustrates an initial discharge curve and an initial charge curve. FIG. 4 indicates that an average discharge voltage is 0.45 V and a discharge capacity is 254 mAh/g when iron oxyhydroxide is used as a positive electrode active material. Here, the average discharge voltage is defined as a discharge voltage at a discharge capacity (here, 127 mAh/g) of ½ of the total discharge capacity.

In addition, the initial charge capacity is 235 mAh/g, which is almost similar to the discharge capacity, and this indicates that the battery is excellent in reversibility.

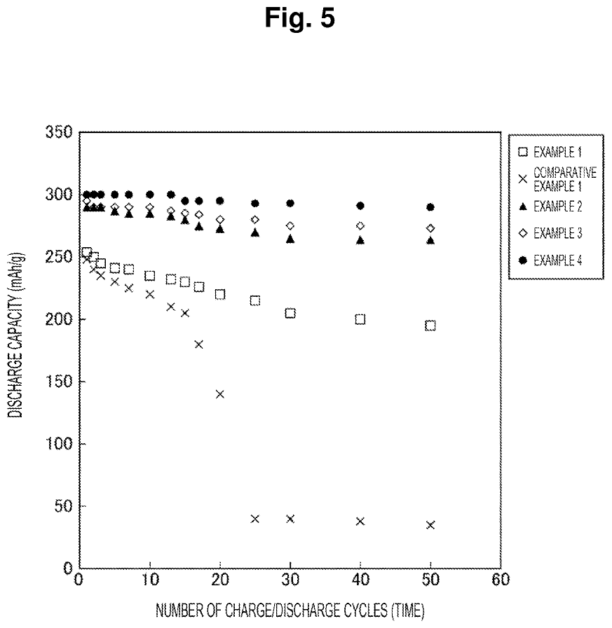

FIG. 5 illustrates cycle dependency of a discharge capacity. In Example 1, when the charge/discharge cycle was repeated 50 times, the discharge capacity decreased by 23% of an initial discharge capacity, but a stable behavior was exhibited as compared with Comparative Example 1 described later. An initial average charge voltage is 0.59 V. The average charge voltage is defined as a charge voltage at a charge capacity of ½ of the total charge capacity. In addition, from FIG. 4, a flat portion can be seen at a voltage of about 0.6 V during charging.

Transition of a charge/discharge voltage is illustrated in Table 1 below. In Example 1, although a slight increase in overvoltage was observed in charge/discharge, it was found that a substantially stable voltage was exhibited. As described above, it was found that the iron-zinc battery had excellent cycle performance.

TABLE 1

| Example | Cycle | First | Fifth | Tenth | Twentieth | Thirtieth | Fiftieth |
|---|---|---|---|---|---|---|---|
| Example 1 | Discharge (V) | 0.45 | 0.44 | 0.41 | 0.40 | 0.38 | 0.36 |
| | Charge (V) | 0.59 | 0.58 | 0.61 | 0.62 | 0.65 | 0.67 |
| Comparative | Discharge (V) | 0.38 | 0.39 | 0.35 | 0.31 | 0.29 | 0.29 |
| Example 1 | Charge (V) | 0.62 | 0.62 | 0.65 | 0.72 | 0.81 | 0.81 |
| Example 2 | Discharge (V) | 0.46 | 0.46 | 0.45 | 0.44 | 0.42 | 0.42 |
| | Charge (V) | 0.57 | 0.57 | 0.58 | 0.58 | 0.59 | 0.60 |
| Example 3 | Discharge (V) | 0.47 | 0.46 | 0.45 | 0.45 | 0.44 | 0.43 |
| | Charge (V) | 0.57 | 0.57 | 0.58 | 0.58 | 0.58 | 0.59 |
| Example 4 | Discharge (V) | 1.40 | 1.36 | 1.34 | 1.34 | 1.30 | 1.26 |
| | Charge (V) | 1.73 | 1.74 | 1.76 | 1.76 | 1.80 | 1.85 |

### Comparative Example 1

In Comparative Example 1, the above-described coin type iron-zinc battery was produced by the following procedure. A zinc plate was used as a negative electrode active material, and a 6 mol/L potassium hydroxide aqueous solution (KOH) was used as a strong alkaline electrolytic solution (having a pH of about 14) for an aqueous electrolytic solution.

Preparation of a positive electrode and a negative electrode other than the aqueous electrolytic solution, and production and evaluation methods of the battery were similar to those in Example 1.

### Battery Performance

Cycle dependencies of a discharge capacity and a charge/discharge voltage of the iron-zinc battery of Comparative Example 1 are illustrated in FIG. 5 and Table 1, respectively. As illustrated in FIG. 5, an initial discharge capacity of Comparative Example 1 was 248 mAh/g, which is equivalent to that of Example 1. However, as illustrated in Table 1, as for the charge/discharge voltage, an increase in overvoltage was observed as compared with Example 1.

When the cycle was repeated, it was found that a stable behavior was exhibited until the 20th cycle. However, thereafter, the discharge capacity was rapidly deteriorated, and a stable behavior was not obtained until the 50th cycle.

This is considered to be because the dendrite grew on the negative electrode and the negative electrode was rapidly deteriorated unlike Example 1.

### Example 2

In Example 2, the above-described coin type iron-zinc battery was produced by the following procedure. In addition, a zinc plate was used as a negative electrode active material, and a zinc chloride (ZnCl₂) concentrated electrolytic solution containing 3 mol of water (H₂O) with respect to 1 mol of zinc chloride (ZnCl₂) was used as an aqueous electrolytic solution.

Preparation of a positive electrode and a negative electrode other than the aqueous electrolytic solution, and production and evaluation methods of the battery were similar to those in Example 1.

### Battery Performance

Cycle dependencies of a discharge capacity and a charge/discharge voltage of the iron-zinc battery of Example 2 are illustrated in FIG. 5 and Table 1, respectively. As illustrated in FIG. 5, an initial discharge capacity of Example 2 was 290 mAh/g, which is larger than that of Example 1. In addition, it was found that a stable behavior was exhibited even when the cycle was repeated.

As illustrated in Table 1, also as for the charge/discharge voltage, a larger decrease in overvoltage was observed as compared with Example 1, and improvement in charge/discharge energy efficiency could be achieved. In addition, also as for the charge/discharge voltage, no significant increase in overvoltage was observed even when the cycle was repeated, and it was confirmed that the operation was stable.

These characteristics are improved because all water molecules in the electrolytic solution are coordinated to zinc ions (Zn²⁺), a reaction between water molecules and zinc is suppressed, a coating film is hardly formed, and an increase in overvoltage can be suppressed.

### Example 3

In Example 3, the above-described coin type iron-zinc battery was produced by the following procedure. In addition, a positive electrode and a negative electrode were applied to a copper sheet-like current collector for preparation, and a zinc chloride (ZnCl₂) concentrated electrolytic solution containing 3 mol of water (H₂O) with respect to 1 mol of zinc chloride (ZnCl₂) was used as an aqueous electrolytic solution.

The battery was produced and evaluated in a similar manner to Example 1.

### Preparation of Positive Electrode

Iron oxyhydroxide powder (particle size: 1 μm, Kojundo Chemical Laboratory Co., Ltd.), Ketjen black powder (EC600JD, Lion Specialty Chemicals), and a styrene-butadiene rubber (AA Portable Power Corporation) were sufficiently mixed at a weight ratio of 80:10:10 using a kneader (THINKY CORPORATION). The produced slurry was applied to a copper foil (The Nilaco Corporation) and dried in a vacuum dryer at 100° C. for 12 hours. Thereafter, the dried product was pressed at 120° C., and this sheet-like electrode was cut into a circle having a diameter of 16 mm to obtain a positive electrode.

### Preparation of Negative Electrode

Zinc iron powder (particle size: 7 μm, Kojundo Chemical Laboratory Co., Ltd.), Ketjen black powder (EC600JD, Lion Specialty Chemicals), and a styrene-butadiene rubber (AA Portable Power Corporation) were sufficiently mixed at a weight ratio of 80:10:10 using a kneader (THINKY CORPORATION). The produced slurry was applied to a copper foil (The Nilaco Corporation) and dried in a vacuum dryer at 100° C. for 12 hours. Thereafter, the dried product was pressed at 120° C., and this sheet-like electrode was cut into a circle having a diameter of 16 mm to obtain a negative electrode.

### Battery Performance

Cycle dependencies of a discharge capacity and a charge/discharge voltage of the iron-zinc battery of Example 3 are illustrated in FIG. 5 and Table 1, respectively. As illustrated in FIG. 5, an initial discharge capacity of Example 3 was 295 mAh/g, which is larger than that of Example 2. In addition, it was found that a stable behavior was exhibited even when the cycle was repeated.

As illustrated in Table 1, also as for the charge/discharge voltage, a larger decrease in overvoltage was observed as compared with Example 2, and improvement in charge/discharge energy efficiency could be achieved. In addition, also as for the charge/discharge voltage, no significant increase in overvoltage was observed even when the cycle was repeated, and it was confirmed that the operation was stable. These characteristics are considered to be improved because the positive electrode active material and the negative electrode active material were applied to the copper sheet-like current collector and formed, and therefore internal resistance of the battery was reduced, and a battery reaction was smoothly performed.

### Example 4

In Example 4, the above-described iron-zinc battery having a bipolar type three-stack structure was produced by the following procedure.

FIG. 3A is an exploded view of the iron-zinc battery having a bipolar type three-stack structure. As the aqueous electrolytic solution, a zinc chloride (ZnCl₂) concentrated electrolytic solution containing 3 mol of water (H₂O) with respect to 1 mol of zinc chloride (ZnCl₂) was used in a similar manner to Example 3.

The battery was evaluated in a similar manner to Example 3. However, in a charge/discharge test, measurement was performed until a discharge voltage decreased to 0.60 V, and measurement was performed until a charge voltage increased to 3.0 V.

### Preparation of Positive Electrode and Negative Electrode

As the positive electrode 101, iron oxyhydroxide powder (particle size: 1 μm, Kojundo Chemical Laboratory Co., Ltd.), Ketjen black powder (EC600JD, Lion Specialty Chemicals), and a styrene-butadiene rubber (AA Portable Power Corporation) were sufficiently mixed at a weight ratio of 80:10:10 using a kneader (THINKY CORPORATION) to produce a slurry. This slurry was applied to a copper foil (The Nilaco Corporation) as the current collector 322 in a size of 2 cm×2 cm, and dried in a vacuum dryer at 100° C. for 12 hours.

Next, as the negative electrode 103, zinc iron powder (particle size: 7 μm, Kojundo Chemical Laboratory Co., Ltd.), Ketjen black powder (EC600JD, Lion Specialty Chemicals), and a styrene-butadiene rubber (AA Portable Power Corporation) were sufficiently mixed at a weight ratio of 80:10:10 using a kneader (THINKY CORPORATION) to produce a slurry. This slurry was applied to a back surface of the copper foil 322 to which the positive electrode 101 had been applied and dried in a size of 2 cm×2 cm, and dried in a vacuum dryer at 100° C. for 12 hours. Thereafter, the dried product was pressed at 120° C. to obtain the bipolar electrode 320 on surfaces of which the positive electrode 101 and the negative electrode 103 were applied, respectively.

However, as for an outermost layer electrode for the positive electrode 101 and an outermost layer electrode for the negative electrode 103, the above-described positive electrode 101 or negative electrode 103 was applied to only one surface of the above-described copper foil (each of the current collectors 303A and 303B). A preparation method is similar to that described above. As the copper foils (the current collectors 303A and 303B) for the outermost layers, copper foils cut into shapes having tabs 313A and 313B were used, respectively.

### Preparation of Iron-Zinc Battery

An iron-zinc battery having a bipolar type three-stack structure illustrated in FIG. 3 was produced using the aluminum laminate film 304.

The two bipolar electrodes 320 prepared by the above method were stacked such that the positive electrode 101 and the negative electrode 103 faced each other, and the separator 301 cut out into a size of 2.2 cm×2.2 cm and the frame-shaped thermally fusible sheet 302 the centers of which had been cut out were inserted between the bipolar electrodes 320. After stacking, three sides of a peripheral portion of the current collectors 322 were thermally pressed at 180° C. to be sealed.

As for outermost layers, similarly to the above, the negative electrode 103, the positive electrode 101, the separator 301, and the thermally fusible sheet 302 for the outermost layer were also stacked such that the positive electrode 101 and the negative electrode 103 faced each other, and the same three sides as the sides sealed above were thermally pressed to be sealed.

The stack thus produced was held with the aluminum laminate film 304 and the thermally fusible sheet 302, and the same three sides as the sides sealed above were thermally pressed to form the aluminum laminate film into a bag shape.

Thereafter, a zinc chloride (ZnCl₂) concentrated electrolytic solution containing 3 mol of water (H₂O) with respect to 1 mol of zinc chloride (ZnCl₂) was injected into each cell (room), the separator 301 was sufficiently immersed therein, then one unsealed side of the aluminum laminate film 304 was vacuum-sealed, and finally one unsealed side of the stack was sealed from above the aluminum laminate film 304, thereby obtaining a bipolar type stack iron-zinc battery.

Note that in Example 4, the number of stacks is three, but it is also possible to produce a bipolar type stack iron-zinc battery having three or more stacks. In this case, it is only required to increase the number of bipolar electrodes 320 to be stacked.

### Battery Performance

Cycle dependencies of a discharge capacity and a charge/discharge voltage of the iron-zinc battery of Example 4 are illustrated in FIG. 5 and Table 1, respectively. As illustrated in FIG. 5, an initial discharge capacity of Example 4 was 300 mAh/g, which is equivalent to that of Example 3. In addition, it was found that a stable behavior was exhibited even when the cycle was repeated.

In addition, as illustrated in Table 1, a charge/discharge voltage is also about three times that of Example 3. Even in a case of an iron-zinc battery having a voltage lower than that of a conventional battery in a unit cell, by forming a bipolar type stack structure iron-zinc battery, a voltage equivalent to that of the conventional battery can be achieved.

In addition, also as for the charge/discharge voltage, no significant increase in overvoltage was observed even when the cycle was repeated, and it was confirmed that the operation was stable.

The iron-zinc battery according to the present invention includes a positive electrode containing iron oxyhydroxide, a negative electrode containing zinc, and an aqueous electrolytic solution disposed between the positive electrode and the negative electrode. The aqueous electrolytic solution contains zinc chloride (ZnCl₂), and the weight of the zinc chloride (ZnCl₂) is equal to or more than the weight of water (H₂O) contained in the aqueous electrolytic solution.

From the above results, the present embodiment can provide an iron-zinc battery having a low environmental load.

In addition, the iron-zinc battery of the present embodiment is a sealed battery that does not require an air intake port unlike an air battery. Therefore, the iron-zinc battery of the present embodiment can be stored for a long period of time without volatilizing an electrolytic solution from the air intake port.

In addition, in the present embodiment, an aqueous electrolytic solution containing zinc chloride (ZnCl₂) is used. As a result, the iron-zinc battery of the present embodiment has excellent reversibility and cycle performance. In addition, by using the aqueous electrolytic solution, it is possible to produce an inexpensive battery having high safety without a risk of fire or explosion.

Therefore, the iron-zinc battery of the present embodiment can be effectively used as a new drive source for various electronic devices such as a small device, a sensor, and a mobile device.

Note that the present invention is not limited to the above embodiment, and various modifications and combinations are possible within the technical idea of the present invention.

### REFERENCE SIGNS LIST

101 Positive electrode
102 Aqueous electrolytic solution
103 Negative electrode
201 Positive electrode case
202 Negative electrode case
203 Propylene gasket
301 Separator
302 Thermally fusible sheet
303A, 303B Outermost layer current collector
304 Aluminum laminate film
320 Bipolar electrode
322 Current collector

1. An iron-zinc battery comprising:
a positive electrode containing iron oxyhydroxide;
a negative electrode containing zinc; and
an aqueous electrolytic solution disposed between the positive electrode and the negative electrode, wherein
the aqueous electrolytic solution contains zinc chloride (ZnCl₂), and
a weight of the zinc chloride (ZnCl₂) is equal to or more than a weight of water (H₂O) contained in the aqueous electrolytic solution.

2. The iron-zinc battery according to claim 1, wherein
the aqueous electrolytic solution is a zinc chloride concentrated electrolytic solution containing 3 mol or less of the water (H₂O) with respect to 1 mol of the zinc chloride (ZnCl₂).

3. The iron-zinc battery according to claim 1, wherein the positive electrode and the negative electrode are applied to a sheet-like current collector containing at least one selected from the group consisting of copper, iron, and carbon.

4. The iron-zinc battery according to claim 1, having a bipolar type stack structure.

5. The iron-zinc battery according to claim 2, wherein
the positive electrode and the negative electrode are applied to a sheet-like current collector containing at least one selected from the group consisting of copper, iron, and carbon.

6. The iron-zinc battery according to claim 2, having a bipolar type stack structure.

7. The iron-zinc battery according to claim 3, having a bipolar type stack structure.
